(19) United States
(12) Patent Application Publication
(10) Pub. No.: US 2014/0058967 A1
(43) Pub. Date: Feb. 27, 2014

(54) SYSTEM AND METHOD FOR PROCESSING VISA APPLICATIONS FOR A PLURALITY OF COUNTRIES

(71) Applicant: Anh Hoang LUONG, Cut Off, LA (US)

(72) Inventor: Anh Hoang LUONG, Cut Off, LA (US)

(73) Assignee: LHA R&D LLC, Galliano, LA (US)

(21) Appl. No.: 13/973,807

(22) Filed: Aug. 22, 2013

Related U.S. Application Data
(60) Provisional application No. 61/692,497, filed on Aug. 23, 2012.

(51) Int. Cl. G06Q 50/26; G06F 17/24

(52) U.S. Cl. CPC G06Q 50/26; G06F 17/243
USPC 705/325

(57) ABSTRACT

The present invention discloses a method for assisting a traveller in the preparation of visa applications. The method includes a step of collecting data for visa applications for one or more countries. In addition, user data of a traveller is stored in a database. Moreover, a visa application selected by the traveller is displayed on a computer. Further the selected application is automatically populated with stored user data.

### CROSS-REFERENCE TO RELATED APPLICATIONS

This application claims priority to U.S. provisional application titled, “SYSTEMS AND METHOD FOR PROCESSING VISA APPLICATIONS FOR A PLURALITY OF COUNTRIES,” filed Aug. 23, 2012, having a Ser. No. 61/692,497, which hereby is incorporated by reference in its entirety.

### BACKGROUND OF THE APPLICATION

1. Field of the Invention

This application generally relates to methods and systems for assisting travellers with preparing and filing visa applications with an embassy, consulate or visa servicing entity prior to travelling to one or more countries. This application also generally relates to methods and systems providing a user-friendly interface for reducing the amount of time typically required to prepare and file visa applications with an embassy or consulate.

2. Related Art

A visa is an official document generally issued by a country authorizing a person to enter or leave therefrom. Visas generally permit non-citizens clearance to enter a country and remain therein with certain constraints, such as a time frame for entry, a limit on the time spent in the country, and a prohibition against employment. Each country may offer different types of visas including but not limited to transit visas, airside transit visas, private visas, tourist visas, business visas, student visas, working holiday visas, temporary worker visas, spousal visa or partner visas, marriage visas, immigrant visas, pensioner visas, diplomatic visas, courtesy visas, and journalist visas.

Whether travelling for business or pleasure, preparing and filing a visa application is a time-consuming part of the planning phase prior to embarking upon international travel. For instance, travellers initially must obtain the most recent visa application from the embassy, consulate or visa servicing entity. Thereafter, travellers must review the specific requirements set forth in application to ensure compliance. Additional time and effort may also be expended contacting the embassy or consulate to clarify requirements deemed vague and/or confusing in the visa application. Further, the traveller must complete the visa application with identifying information including but not limited to legal name, address, social security number, citizenship, passport number, bank records, utility bills, mortgage statements. When travellers visit multiple countries, the time needed to accurately complete each of the visa applications significantly increases.

Selecting the appropriate visa application may also pose difficulties to some travellers. For example, a traveller visiting one or more countries, for multiple reasons, may be unsure of which visa application is most appropriate for their individual circumstance. While the traveller may certainly contact the consulate to receive guidance, the traveller may experience long waiting times and/or inadequate assistance. Accordingly, delays in completing and filing the visa application occur.

What is desired in the art is a user-friendly method and system for assisting travellers with planning, preparing and/or filing one or more visa applications.

Also desired in the art is a method and system for reducing the time required to complete one or more visa applications.

Further desired in the art is a method and system for reducing and/or eliminating typographic errors in a visa application.

Even further, it is desired in the art to provide a method and system which provides a traveller with the likelihood of compliance with the requirements of one or more visa applications.

Yet even further, it is desired in the art to provide travellers with an easy-to-navigate web-based platform providing relevant information for the desired countries of travel.

### SUMMARY OF THE INVENTION

According to a first aspect of the invention, there is disclosed a method for assisting a traveller in the preparation of one or more visa applications. The method includes the steps of (i) collecting data for said one or more visa applications for one or more countries; (ii) storing user data received by the traveller in a database; (iii) displaying one of the visa applications selected by the traveller on a display of a computer; and (iv) automatically populating the selected visa application displayed on the display with the stored user data.

According to a second aspect of the invention, there is disclosed a system for assisting a traveller with the preparation of one or more visa applications. The system comprises a data storage unit having stored therein user data collected from said traveller, and data of said one or more visa applications for one or more countries. The system also includes a platform, operating on a networked computer, and coupled to the data storage unit. The platform includes: (i) a communication module configured to display one of said visa applications selected by the traveller on a display of the computer; and (ii) a processing module configured to automatically populate the selected visa application displayed on the display with the stored user data.

According to a third aspect of the invention, there is disclosed a software platform application including computer readable instructions, executable by processor of a networked computer.

There has thus been outlined, rather broadly, certain aspects of the present invention in order that the detailed description thereof herein may be better understood, and in order that the present contribution to the art may be better appreciated. There are, of course, additional aspects of the present invention that will be described below and which will form the subject matter of the claims appended hereto.

In this respect, before explaining at least one aspect of the present invention in detail, it is to be understood that the present invention is not limited in its application to the details of construction and to the arrangements of the components set forth in the following description or illustrated in the drawings. The present invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this application is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be illustrative only.

FIG. 1 illustrates a web application visa processing system in accordance with an embodiment of the present invention.

FIG. 2 illustrates a block diagram of hardware components of a mobile wallet visa processing system in accordance with an embodiment of the present invention.

FIG. 3 illustrates a flow chart illustrating the functionality of a web application visa processing system according to an embodiment of the present invention.

FIG. 4 illustrates a graphical user interface displayed on a user device in accordance with an embodiment of the present invention.

FIG. 5 illustrates a graphical user interface displayed on a user device in accordance with another embodiment of the present invention.

FIG. 6 illustrates a graphical user interface displayed on a user device in accordance with yet another embodiment of the present invention.

FIG. 7 illustrates a graphical user interface displayed on a user device in accordance with yet even another embodiment of the present invention.

FIG. 8. illustrates a graphical user interface displayed on a user device in accordance with yet even a further embodiment of the present invention.

### DETAILED DESCRIPTION

As an initial matter, reference in this specification to “one aspect,” “an aspect,” “other aspects,” “one or more aspects” or the like means that a particular feature, structure, or characteristic described in connection with the aspect is included in at least one aspect of the invention. The appearances of, for example, the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not other aspects.

The aspects of this invention generally are directed to methods and systems offering a platform to travellers for researching, preparing and filing one or more visa applications with countries, embassies or consulates. The methods and systems preferably include but are not limited to visa application forms, travel requirements and travel advisories on user selected countries updated in real-time. For instance, travel advisories may include safety reports, weather reports, political information, conflicts, and outbreaks, which may be ongoing in the selected country of travel. Moreover, the traveller is informed of other precautions, such as pre- and post-vaccinations, advised for the selected country of travel. By so doing, the traveller is provided with the most accurate information to ensure compliance with the requirements set forth in each visa application for one or more countries. Ultimately, the aspects of the methods and systems described in this invention help improve efficiency and accuracy with preparing and filing visa applications for one or more countries.

In a first aspect of the instant invention, there is disclosed a web platform providing travellers with assistance in planning, preparing and filing a visa application in one or more countries, embassies and/or consulates. In an exemplary embodiment, the platform may be utilized via the Internet accessible via a web browser displayed on a computer. One of the many ways in which the method and system assists travellers are by automatically populating visa applications with stored user information. By so doing, user time associated with inputting common user information for one or more visa applications significantly is reduced.

In another aspect of the invention, there is disclosed a web platform configured to review a visa application prepared by a traveller. The platform determines whether one or more portions of the application are missing. In one embodiment, the web platform informs the user or traveller via a text box indicating which sections require completion. In another embodiment, the web platform directs the user or traveller to the specific sections which require completion.

In yet another aspect of the platform there is disclosed a web platform configured to determine whether the user meets the requirements or conditions set forth for one or more visa applications. In an exemplary embodiment, the web platform compares data input by a user or traveller with the requirements set forth in one or more visa applications. In yet another exemplary embodiment, the web platform identifies which requirements are not met by the traveller. In a further exemplary embodiment, the web platform identifies what information is necessary to comply with the requirements set forth in the visa application.

In yet even another aspect of the application, there is disclosed a web platform including information on user selected countries with respect to history, and travel advisories and precautions. In an exemplary embodiment, the travel advisories include, but are not limited to, weather reports, political information, outbreaks, pre- and post-vaccinations. Relevant travel information may also include, but is not limited to, tour agencies, lodging, local transportation, flights, current exchange rates, travel registration and/or other information that may be considered helpful to a traveller. In a further exemplary embodiment, the travel advisories are provided in real-time to the traveller, from news and reporting agencies, and condensed in a succinct format for easy review by the traveller.

### System

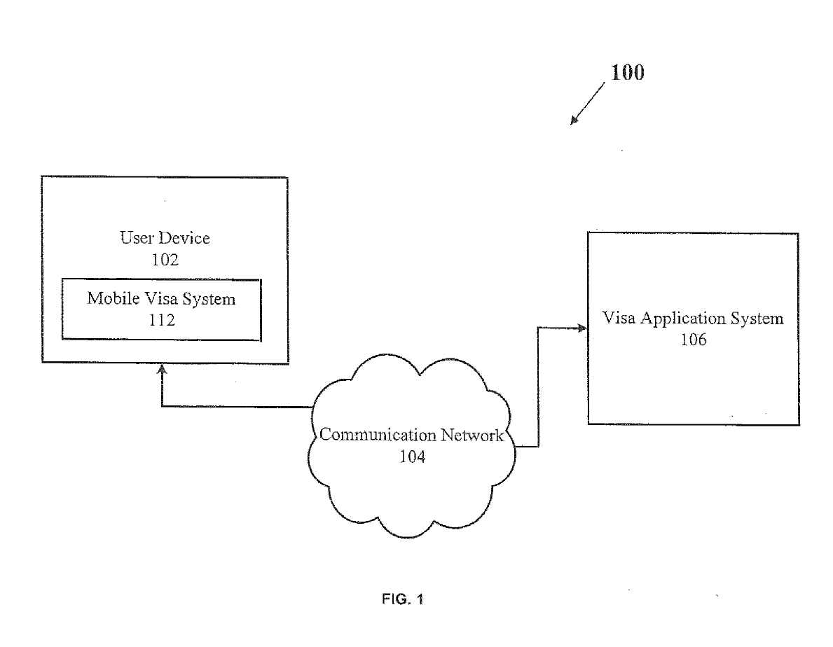

Referring to FIG. 1, there is shown a web platform visa processing system 100 in accordance with an embodiment of the present invention. The web platform visa processing system 100 may include a user device 102 communicatively coupled to a visa application system 106. The user device 102 may include a mobile visa system 112 that may be used to apply for a visa of a desired country. For example, the mobile visa system 112 may store different types of visa applications for a plurality of countries and user information.

In one aspect of the application, the mobile visa system 112 receives a selection of a type of visa application for a country from a user. In one embodiment, the visa system 112 automatically populates the selected visa application with previously stored user information. In an exemplary embodiment, the mobile visa system 112 determines whether additional user information is needed to complete the user selected visa application, and alerts the user accordingly. In another exemplary embodiment, the mobile visa system 112 stores requirements or conditions of the plural types of visa applications for the plurality of countries, and determines the likelihood of whether the user's stored and previously provided information would qualify the user in obtaining a visa for the selected country. In yet a further exemplary embodiment, the mobile visa system 112 provides suggestions on how to improve the likelihood of obtaining a visa for a selected country based upon user current or previously inputted information.

While the mobile visa system 112 is shown as residing on the user device 102, the mobile visa system 112 alternatively may be located entirely or partially on the visa application system 106, or a secondary system separate from the user device 102. This secondary system may include a database, server, or the like that connects to the communication network 104 and provides the functionality described herein.

In an exemplary embodiment, the user device 102 may include, but is not limited to, a mobile phone, a smart phone, a computer, a personal computer, a laptop, a cellular communication device, a workstation, a mobile device, a phone, a television, a handheld PC, a personal digital assistant (PDA), a tablet computer, a thin system, a fat system, a network appliance, an Internet accessible device, netbook, tablet computer, or other any other device that may be in communication with the visa application system 106 via the communication network 104. Alternatively, the user device 102 may be coupled to the visa application system 106 via a wired link. In another exemplary embodiment, the user device 102 may be coupled to the visa application system 106 via a wireless link or a combination of a wired link and a wireless link.

The communication network 104 may couple the user device 102 to the visa application system 106. The communication network 104 may be a wireless network, a wired network or any combination of wireless network and wired network. For example, the communication network 104 may include one or more of a fiber optic network, a passive optical network, a cable network, an Internet network, a satellite network, e.g., operating in B and C, and Kᵤ or B and Kₐ), a wireless LAN, a Global System for Mobile Communication (GSM), a Personal Communication Service (PCS), a long term evolution (LTE) network, a Personal Area Network (PAN), D-AMPS, Wi-Fi, Fixed Wireless Data, IEEE 802.11a, 802.11b, 802.15.1, 802.11n and 802.11g network or any other wired or wireless network for transmitting and receiving a data signal. In addition, the communication network 104 may include, without limitation, telephone line, fiber optics, IEEE Ethernet 802.3, wide area network (WAN), local area network (LAN), or global network aspects such as the Internet. The communication network 104 may support an Internet network, a wireless communication network, a cellular network, or the like, or any combination thereof.

In a further embodiment, the communication network 104 may further include one, or any number of the exemplary types of networks mentioned above operating as a stand-alone network, or in cooperation with each other. While the communication network 104 illustrated in FIG. 1 is one network, the invention also is intended to cover a plurality of interconnected networks, such as, for example, a service provider network, a broadcaster's network, a cable television network, corporate networks, home networks and the like.

The visa application system 106 may include one or more servers. For example, the visa application system 106 may include a UNIX based server, Windows 2000 Server, Microsoft IIS server, Apache HTTP server, API server, Java server, Java Servlet API server, ASP server, PHP server, HTTP server, Mac OS X server, Linux server, Oracle server, IP server, other independent server or the like to support operations of a client. Also, the visa application system 106 may include one or more of an Internet Protocol (IP) network server or public switch telephone network (PSTN) server. The visa application system 106 may include one or more databases for storing a network model topology and network policies based at least in part on the network model topology.

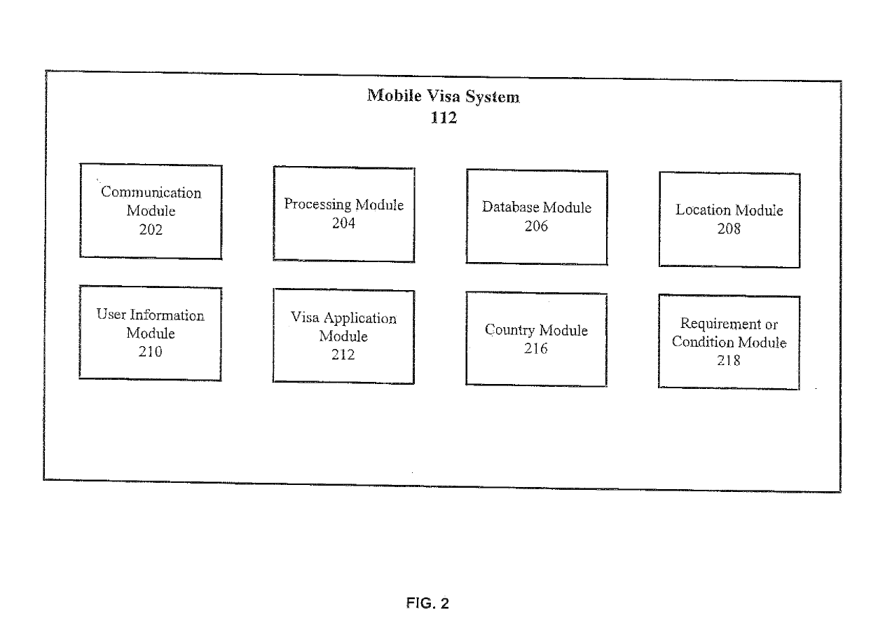

FIG. 2 is a block diagram of hardware components of the mobile visa system 112 of the web application visa processing system 100 in accordance with another aspect of the present invention. In an exemplary embodiment, the mobile visa system 112 may be implemented on the user device 102. For example, the mobile visa system 112 may be stored on a memory of the user device 102 and executed by a computer processor, preferably also on the user device 102. Also, the mobile visa system 112 may be configured such that information may be displayed on the user device 102 to provide information to the user. A keypad and/or touchscreen of the user device 102 may be employed so the mobile visa system 112 is capable of receiving information from the user.

In an exemplary embodiment, the mobile visa system 112 may include one or more of the following modules: a communication module 202, a processing module 204, a database module 206, a location module 208, a user information module 210, a visa application module 212, a country module 216 and a travel inquiry module 218. Each will be discussed below in more detail. In another exemplary embodiment, the functions performed by any of modules 202-218 may be combined with the functions performed by other modules. In an alternative embodiment, the functions described herein as being performed by modules 202-218 also may be separated and may be located elsewhere, or performed by other modules.

### Communication Module

In an exemplary embodiment, the communication module 202 may include transceivers and/or a computer processor to establish a communication path with the visa application system 106 via the communication network 104. For example, the communication module 202 may include a user interface, e.g., a graphical user interface (GUI), an application programming interface (API)) or the like to transmit information between the mobile visa system 112 and the visa application system 106. For example, the communication module 202 may include a separate or unified graphical user interface to communicate with the consumer.

In another example, the communication module 202 may include an application programming interface (API) or the like to communicate with the visa application system 106. The communication module 202 may be communicatively coupled to other modules of the mobile visa system 112. For example, the communication module 202 may receive information from the user and the visa application system 106 and provide the information to other modules of the mobile visa system 112. In an exemplary embodiment, the communication module 202 may provide the received information to the processing module 204 for processing or the database module 206 for storing.

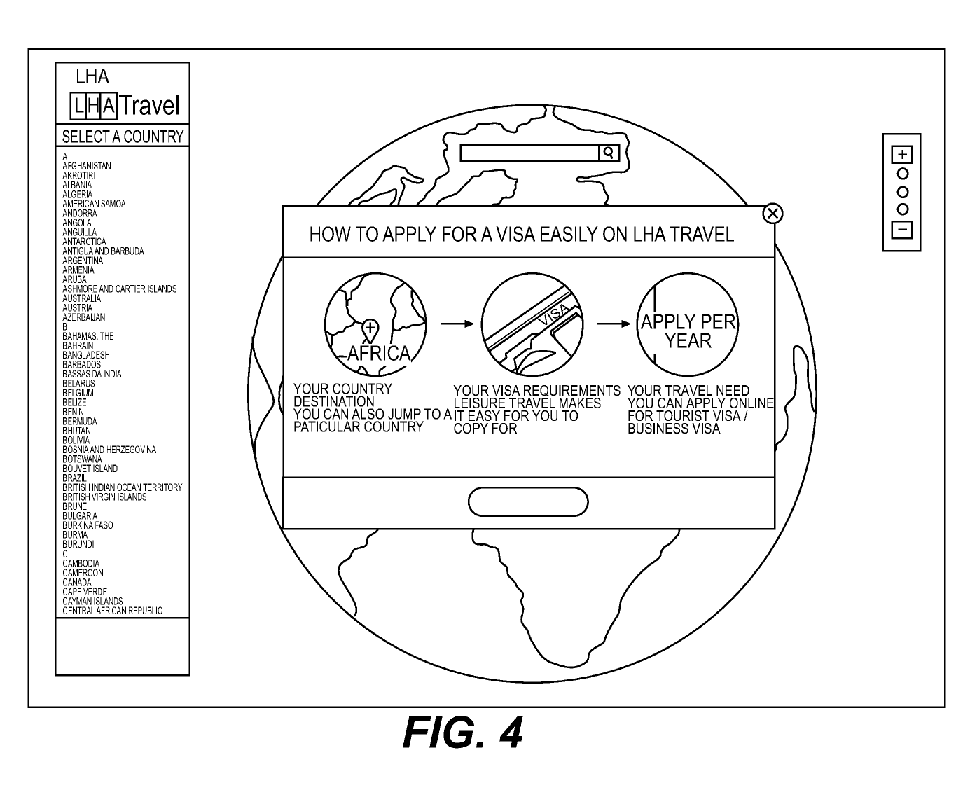

A graphical user interface of the web-based visa application system is displayed on a user display as shown in FIG. 4. Specifically, the graphical user interface provides search box for locating a specific country for travel. A rolodex of available countries may also be provided on the user interface, either on the main screen or secondary screen. The graphical user interface provides one or more of the following tools: information relating to the selected country, information regarding visa requirements for a specific country and an only visa application filing tool.

According to any of the illustrations provided of the graphical user interface, the mobile visa system 112 may also display various visa applications available for the selected country, e.g., tourist visa, student visa business visa and other types of visa applications. Further, the mobile visa system 112 may determine requirements or conditions for the user to travel to the selected country. The user may inquiry the mobile visa system 112 for additional information. For example, a user may inquire the mobile visa system 112 about additional information regarding a desired country. Also, a user may inquire the mobile visa system 112 of a map of a desired country.

In further alternative embodiments, once the visa process is completed, the user may be presented with options to purchase travel ticket, car rentals, and hotels. Additionally, information about the culture, dress code, behavior code, suggested shots, exchange rates, tour guides, and eating and shopping suggestions may also be presented to the user.

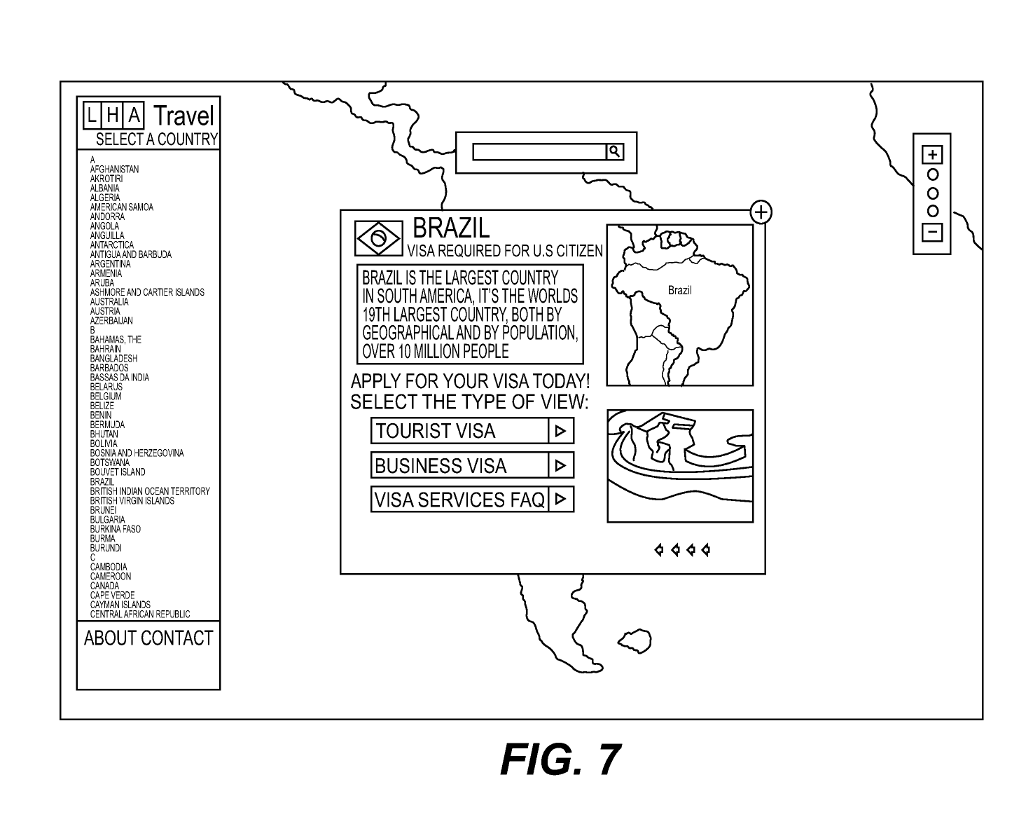

In one embodiment, graphical user interface illustrating information on a specific country, e.g., Brazil is shown in FIG. 7. The main screen or sub screen provides relevant information on the country including at least a map and short description. The user interface may also provide a status to the user, based upon individual user input, regarding whether a visa is required to travel to the selected country. For example, FIG. 7 indicates that a visa is required for U.S. Citizens. The user interface provides a link or access to different visa applications based upon business travel or leisurely travel. The user interface may also provide visa information for the country. The user interface may also provide general travel information on the country regarding alerts and watches. For example, the alerts may indicate severe weather, natural disaster, political instability, and viral outbreaks. Other information which may be of interest to the traveller may include exchange rate information, general prices for common goods of sale, commonly used local words, and tourist traps.

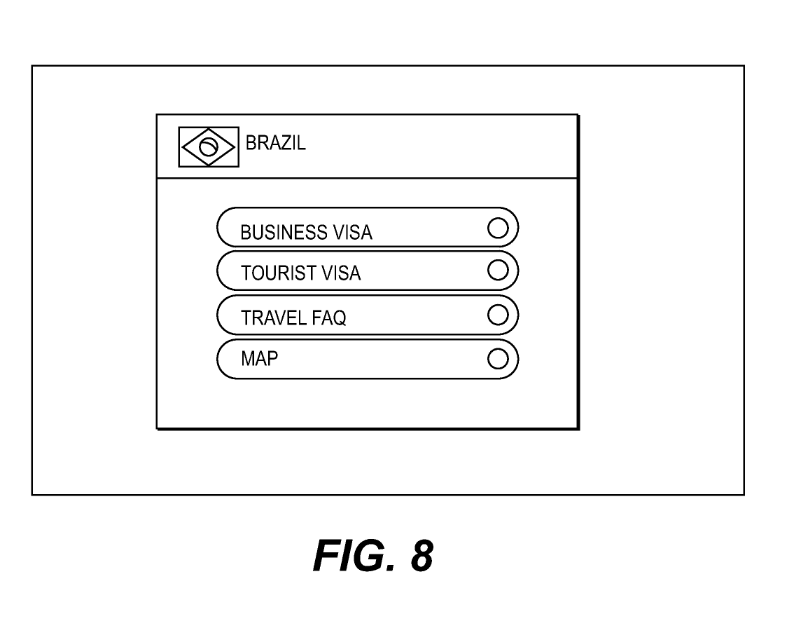

In an alternative embodiment, graphical user interface illustrating information on a country, e.g., Brazil, is shown in FIG. 8. In contrast with FIG. 7, FIG. 8 hides the map and short summary of the country in the main screen. FIG. 8 lists four options on the main screen including: ‘Business visas’, ‘Tourist visas’, ‘Travel FAQ’ and ‘Map’.

### Location Module

In an exemplary embodiment, the location module 208 may include at least one global positioning system (GPS) device, a geomagnetic sensor, a local positioning system (LPS), a triangulation system, a trilateration system, a multi-lateration system, an indoor positioning system, a hybrid positioning system, a real-time locating system, a dynamic positioning system and/or other positioning system that may determine a location of the user device 102 and the user. The location information may include an address, a zone, a town, a village, a city, a county, a state, a province, a region, a country, a continent, longitudinal and latitudinal coordinates or the like that may identify a location of the user device 102.

The location module 208 may provide the location information to other modules, e.g., the communication module 202, the processing module 204, the database module 206, the user information module 210, the visa application module 212, the country module 216 and the travel inquiry module 218 of the mobile visa system 112 for processing. Also, the location module 208 may provide the location information to the visa application system 106.

### User Information Module

In an exemplary embodiment, the user information module 210 may store various user information of the user. The user information module 210 may include or use a computer processor and/or a physical memory database to store the various user information of the user. The user information may be stored on the user device 102, as stated, for easy access or stored at a remote location. The user information may be encrypted on the user device 102 or the remote location. In another exemplary embodiment, the user information stored in the user information module 210 may be grouped based on corporate accounts, family accounts, friend accounts, partner accounts, and/or individual accounts.

In another exemplary embodiment, the user information module 210 may communicate directly with the visa application system 106. Alternatively, the user information module 210 may communicate indirectly with the visa application system 106 via communication module 202.

In a further exemplary embodiment, the visa application system 106 may directly or indirectly provide updated user information of the user to the user information module 210. This may be appropriate in cases where the user has inputted information into a visa application which is not stored in the user information module 210. The user information stored in the user information module 210 may be updated periodically. For example, the user information may be updated daily, weekly, monthly, quarterly, seasonally, yearly and/or other predetermined period of time.

Any type of user information that is reasonably required for visa applications may be stored on the user information module. The user information may include but is not limited to: the user's full legal name, date of birth, height, weight, last visa application, passport number, passport expiration date, passport issuing country, a picture, social security number, address, phone number, sex, electronic mail address, website address, number of years lived at various addresses, family members, marital status, income, employment, country traveled, past visa obtained, spending habits, age and/or other information of a user.

### Visa Application Module

In an exemplary embodiment, the visa application module 212 may include or use a computer processor or a database to process and store a plurality of types of visa applications for a plurality of countries. For example, the plurality types of visa applications may include but are not limited to transit visas, airside transit visas, private visas, tourist visas, business visas, student visas, working holiday visas, temporary worker visas, spousal visas or partner visas, marriage visas, immigrant visas, pensioner visas, diplomatic visas, courtesy visas, journalist visas and/or other types of visa applications.

The visa application module 212 may include various types of visa applications for every country in the world. The visa applications may be in English. Alternatively, the visa applications are in a language recognized by the specific country in which the visa is being applied for. In another example, the visa application module 212 may include various types of visa application of all countries having a diplomatic relationship with the country of the user. In other example, the visa application module 212 may include various types of visa applications for different countries selected by the user.

### The Country Module

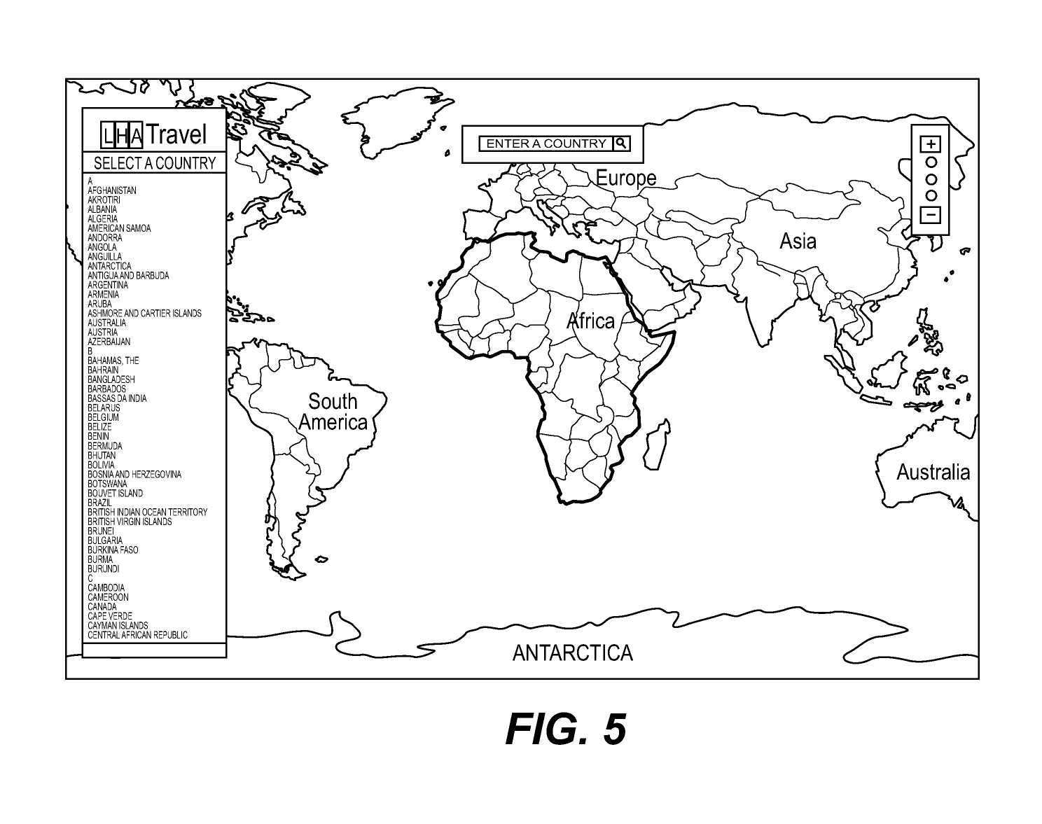

In an exemplary embodiment, the country module 216 may include or use a computer processor and a database to store countries of the world. For example, the country module 216 may include a map of all the countries of the world. The country module 216 may group the countries based on a continent. In an exemplary embodiment as shown in FIG. 5, the country module 216 may include a mapping of the earth for displaying countries and continents on a user display of the user device 102. A search box may also be available for quick key word searching.

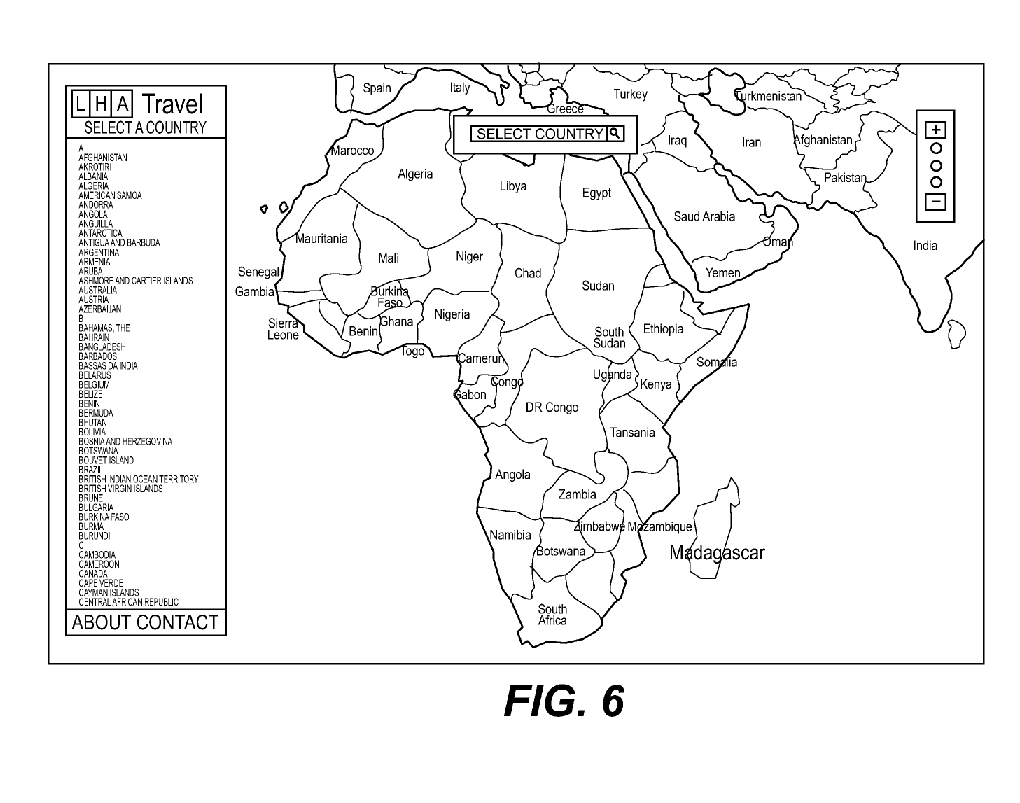

In another exemplary embodiment as shown in FIG. 6, the country module 216 may receive a selection of a continent, e.g., Africa, and a selection of country that a user may want to prepare and file a visa application. A search box may also be available for quick key word searching. The country module 216 may provide the selection to other modules of the mobile visa system 112, e.g., the communication module 202, the processing module 204, the database module 206, the location module 208, the user information module 210, the visa application module 212, the country module 216 and/or the travel inquiry module 218).

### Processing Module

In an exemplary embodiment, the processing module 204 may determine user information based at least in part on the location information. For example, the processing module 204 may determine an address, a country of citizenship, country and continent where the user is located based at least in part on the location information (ex. GPS). The processing module 204 may provide the user information to the database module 206 for storage. Also, the processing module 204 may provide the user information to the user information module 210.

The processing module 204 may receive the selection of the continent and country from the country module 216 and may access the visa application module 212 to obtain various types of visa applications of the selected country. The visa application module 212 may provide all or some of the visa applications of the selected country to the user. In an exemplary embodiment, the processing module 204 may obtain user information from the user information module 210 and determine one or more visa applications that the user may be qualified to apply for based on the user information. The visa application module 212 may provide one or more visa applications qualified for the user. The visa application module 212 may receive a selection of a type of visa that a user desires to apply for. The visa application module 212 may provide the selection to other modules of the mobile visa system 112, e.g., the communication module 202, the processing module 204, the database module 206, the location module 208, the user information module 210, the visa application module 212, the country module 216 and/or the travel inquiry module 218.

The processing module 204 may receive the selection of a visa application from the visa application module 212. The processing module 204 may prompt the user for information to fill out the selected visa application. The processing module 204 may populate the selected visa application with the provided user information. Also, the processing module 204 may provide the received user information to the user information module 210 where it is located and stored for future use. In another example, the processing module 204 may automatically populate the selected visa application with user information stored in the user information module 210. The user may verify whether the user information is accurate and may provide updated user information if the user information is not accurate. If updated user information is provided, the user information module 210 may update the user information stored therein.

### Travel Inquiry Module

In an exemplary embodiment, the travel inquiry module, e.g., requirement/condition module, 218 may include or use a computer processor and a database to store requirements or conditions necessary to apply for a visa in a country. For example, the travel inquiry module 218 may provide a brief description of a country, e.g., official language, geographical description, geopolitical description, travel alerts, medical alerts and/or other information of the country as discussed above.

In another exemplary embodiment, the travel inquiry module 218 may indicate whether a visa is required for a non-citizen travelling to a foreign country in addition to any restrictions of the second country. For example, the travel inquiry module 218 may indicate that a visa is not required for a U.S. citizen when travelling to a country that is part of the European Union. In another exemplary embodiment, the travel inquiry module 218 may indicate that a visa is required for a U.S. citizen when travelling to Brazil. In other examples, the travel inquiry module 218 may indicate that a U.S. citizen is not allowed to travel to North Korea. In other examples, the travel inquiry module 218 for multiple entries into one or more countries can provide information about certain restrictions like visiting Israel before entering Saudi Arabia or vice versa, or the number of days a user must leave a country before reentering and whether different type of visa is needed for reentry.

The travel inquiry module 218 may access the user information module 210 to obtain user information and automatically determine whether the user may be qualified to apply for a visa of a country based at least in part on the user information. For example, the travel inquiry module 218 may determine a country of citizenship of the user based at least in part on the user information. The travel inquiry module 218 may automatically determine whether the citizenship of the user prevents her from travelling to any countries.

In yet another exemplary embodiment, the travel inquiry module 218 may determine that the user has an asset of over five million dollars and may determine that the user qualifies for an investment visa with a minimum amount of half million dollars. In another example, the travel inquiry module 218 may obtain travel alerts from various third party sources (e.g., embassies, State Department, weather forecast centers) and may provide a warning to the user that may be travelling to a country having one or more travel alerts.

### Database Module

In an exemplary embodiment, the database module 206 may store information input by the user for applying to one or more visa applications. The database module 206 may also store information relating to one or more visa applications. The database module 206 may also store travel inquiry information.

### Process

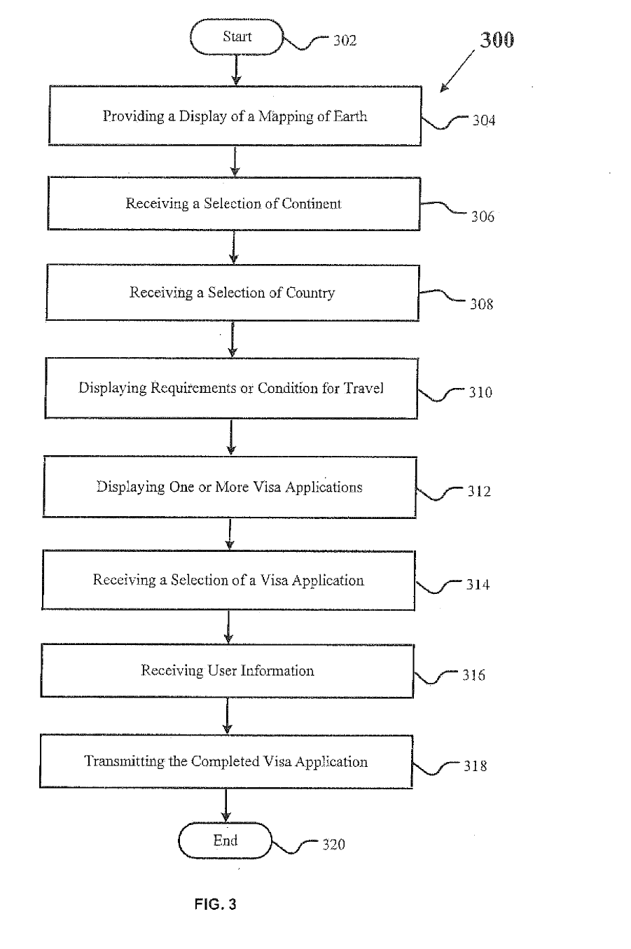

FIG. 3 is a flow chart illustrating the functionality of the mobile visa system 112 according to another aspect of the present invention. In an exemplar embodiment, the method 300 shown in FIG. 3 can be executed or otherwise performed by one or a combination of various systems including the systems and networks shown in FIGS. 1 and 2, by way of example, and various elements of the systems and networks are referenced in explaining the example method of FIG. 3. Each block shown in FIG. 3 represents one or more processes, methods or subroutines carried out in exemplary method 300. In one embodiment, the steps may be performed in ascending order. In another embodiment, any of the steps may be performed outside of the ascending order shown in FIG. 3.

The method 300 for processing a visa application using the mobile visa system 112 may be started at STEP 302.

At STEP 304, a mapping of the earth may be provided to a user. For example, the country module 216 may provide a 3-dimensional (3D) display of the earth having continents and countries to the user. In another example, the country module 216 may provide a 2-dimensional (2D) display of the earth having continents and countries to the user. The user may manipulate a mapping of the earth to spin to the desired country, type in a desired country, or scroll to a desired country in a search field.

As described above and further herein, FIG. 4 illustrates a graphical user interface displayed on a user device 102 in accordance with an embodiment of the present invention. Features and instructions provided by the mobile visa system 112 may be displayed for user that is applying for visa. For example, the mobile visa system 112 may provide instruction on how to select “Your country destination,” “Your Visa Requirements,” and “Your Travel Needs.” Also, the mobile visa system 112 may provide a “Start Navigating” button for the user to apply for visa.

As described above and further herein, FIG. 5 is an illustration of a graphical user interface displayed on a user device 102 in accordance with another embodiment of the present invention. For example, a two-dimensional (2D) map of the world may be displayed to the user. The user may select a continent that the user may wish to travel. The selected continent may be highlighted in order to show the selection of the user. In an exemplary embodiment, the user may select the Africa continent.

As described above and further herein, FIG. 6 is an illustration of a graphical user interface displayed on a user device 102 in accordance with another embodiment of the present invention. After a selection of the desired continent, the mobile visa system 112 may display the countries within the selected continent to the user. The user may select a country within the continent for travel.

At STEP 306, a selection of a continent may be received. The country module 216 may receive a selection of a continent where the user may want to travel. For example, a user may select a continent by clicking on an area of the display corresponding to the desired continent. In another example, a user may select a continent by touching/pressing on an area of the display corresponding to the desired continent. The country module 216 may display all of the countries on the selected continent.

At STEP 308, a selection of a country may be received. The country module 216 may receive a selection of a country where the user may want to travel. For example, a user may select a country by clicking on an area of the display corresponding to the desired country. In another example, a user may select a country by touching/pressing on an area of the display corresponding to the desired country. The country module 216 may display all of the countries on the selected continent.

At STEP 310, requirements or conditions for traveling to the selected country may be displayed. For example, the travel inquiry module 218 may provide a brief description of the selected country, e.g., official language, geographical description, geopolitical description, travel alerts and/or other information of the country). After displaying requirements or conditions of the selected country, the method 300 may move to STEP 312.

At STEP 312, one or more visa application of the selected country may be displayed. The visa application module 212 may provide one or more visa applications that are available for the selected country. Also, the visa application module 212 may provide a brief description of the various visa applications.

At STEP 314, a selection of the visa application may be received. The user may select a visa application type that may be appropriate for the user. For example, a student may select a student visa application. In another example, a business executive may select a business visa application. In other examples, a tourist may select a tourist visa application. The user information module 210 may prompt the user for the user information necessary for the selected visa application type.

At STEP 316, user information may be received. The user information module 210 may provide step-by-step directions/guidance for completing the selected visa application. For example, for each STEP in filling out the visa application, the user information module 210 may prompt the user for the necessary user information for the STEP in order to complete the selected visa application. In another example, the user information module 210 may automatically populate the selected visa application with stored user information. In the event that the user information stored in the user information module 210 is not enough to complete the selected visa application, the user information module 210 may prompt the user for the missing user information to complete the selected visa application. In one embodiment, moving a cursor over the form may also prompt a text box with a description of a blank in the form.

At STEP 318, the completed visa application may be transmitted to the embassy or consulate of the selected country or visa servicing entity including any credit card information previously stored by the user. For example, the communication module 202 may transmit the completed visa application with user information, e.g., automatically populated or provided by the user, to the embassy or consulate of the selected country to obtain a visa. After transmitting the completed visa application, the method 300 may proceed to STEP 320. The transmission may be performed electronically, by mail, or hand. Alternatively, the electronic transmission may send to the visa application system which files the application on behalf of the user.

The method 300 for processing the visa application using the mobile visa system 112 may end at STEP 320.

### Hardware

The hardware elements, operating systems and programming languages of such computers are conventional in nature, and it is presumed that those skilled in the art are adequately familiar therewith. Of course, the server functions may be implemented in a distributed fashion on a number of similar platforms, to distribute the processing load.

Hence, aspects of the disclosed techniques can be executed on a network element such as a server. Program aspects of the disclosed techniques may be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules thereof, such as various semiconductor memories, tape drives, disk drives and the like, which may provide storage at any time for the software programming. All or portions of the software may at times be communicated through the Internet or various other telecommunication networks, Such communications, for example, may enable loading of the software from one computer or processor into another computer or processor. For example, software and/or instructions may be communicated from a server to a client. Similarly, software for a server may be loaded into the hardware platform or platforms selected to perform that server function. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

For the purposes of this invention a computer readable medium stores computer data, which data can include computer program code that is executable by a processor of the SIM or mobile device, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and nonremovable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage media, magnetic cassettes, magnetic tape, magnetic disk storage or other magnetic storage devices, or any other physical or material medium which can be used to tangibly store the desired information or data or instructions and which can be accessed by a processor or computing device. In one or more aspects, the actions and/or events of a method, algorithm or module may reside as one or any combination or set of codes and/or instructions on a computer readable medium or machine readable medium, which may be incorporated into a computer program product.

The present invention may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi), Bluetooth, and/or the like, and/or a combination of two or more thereof.

In an embodiment, the present invention may be implemented in any type of mobile smartphones that are operated by any type of advanced mobile data processing and communication operating system, such as, e.g., an Apple iOS operating system, a Google Android operating system, a RIM Blackberry operating system, a Nokia Symbian operating system, a Microsoft Windows Mobile operating system, a Microsoft Windows Phone operating system, a Linux operating system or the like.

Further in accordance with various aspects of the present invention, the methods described herein are intended for operation with dedicated hardware implementations including, but not limited to, microprocessors, PCs, PDAs, SIM cards, semiconductors, application specific integrated circuits (ASIC), programmable logic arrays, cloud computing devices, and other hardware devices constructed to implement the methods described herein.

The present invention is not to be limited in scope by the specific embodiments described herein. Indeed, other various embodiments of and modifications to the present invention, in addition to those described herein, will be apparent to those of ordinary skill in the art from the foregoing description and accompanying drawings. Thus, such other embodiments and modifications are intended to fall within the scope of the present invention. Further, although the present invention has been described herein in the context of at least one particular implementation in at least one particular environment for at least one particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein.

What is claimed is:

1. A method for assisting a traveller in the preparation of one or more visa applications comprising the steps of:
collecting data for said one or more visa applications for one or more countries;
storing user data received by said traveller in a database;
displaying one of said visa applications selected by said traveller on a display of a computer; and
automatically populating said selected visa application displayed on said display with said stored user data.

2. The method according to claim 1, further comprising:
comparing said user data in view of said selected visa application to determine likelihood of said traveller obtaining a visa; and
displaying said determination on said display.

3. The method according to claim 1, further comprising:
receiving a selection of a desired country of travel from said traveller.

4. The method according to claim 3, further comprising:
determining visa requirements for said selected country in view of said user data; and
displaying said determination on said display.

5. The method according to claim 3, further comprising:
displaying travel information of said selected country on said display.

6. The method according to claim 5, wherein said travel information is selected from safety reports, news, weather reports, natural disasters, political information, regional conflicts, viral outbreaks, vaccinations, currency exchange rates, tour agencies, lodging, flights, travel registration and combinations thereof.

7. The method according to claim 1, further comprising:
alerting said user of missing information in said populated visa application.

8. The method according to claim 1, further comprising:
electronically transmitting said populated visa application to an embassy, consulate or visa servicing entity for purposes of obtaining a visa.

9. The method according to claim 1, wherein said one or more visa applications is selected from transit visas, airside transit visas, private visas, tourist visas, business visas, student visas, working holiday visas, temporary worker visas, spousal visas or partner visas, marriage visas, immigrant visas, pensioner visas, diplomatic visas, courtesy visas, journalist visas and combinations thereof.

10. The method according to claim 1, wherein said user data is selected from legal name, address, social security number, citizenship, marital status, passport number, bank records, utility bills, mortgage statements and combinations thereof.

11. A system for assisting a traveller with the preparation of one or more visa applications, the system comprising:
a data storage unit having stored therein user data collected from said traveller, and data of said one or more visa applications for one or more countries; and
a platform, operating on a networked computer, and coupled to said data storage unit, said platform including: (i) a communication module configured to display one of said visa applications selected by said traveller on a display of said computer; and (ii) a processing module configured to automatically populate said selected visa application displayed on said display with said stored user data.

12. The system according to claim 11, wherein
said processing module is configured to compare said user data in view of said selected visa application to determine likelihood of said traveller obtaining a visa, and
said communication module is configured to display said determination on said display.

13. The system according to claim 11, wherein said processing module is configured to receive a selection of a desired country of travel from said traveller.

14. The system according to claim 13, wherein
said processing module is configured to determine visa requirements for said selected country in view of said user data, and
said communication module is configured to display said determination on said display.

15. The system according to claim 13, wherein said communication module is configured to display travel information of said selected country on said display.

16. The system according to claim 15, wherein said travel information is selected from safety reports, news, weather reports, natural disasters, political information, regional conflicts, viral outbreaks, vaccinations, currency exchange rates, tour agencies, lodging, flights, travel registration and combinations thereof.

17. The system according to claim 11, wherein said processing module is configured to alert said user of missing information in said populated visa application.

18. The system according to claim 11, wherein said communication module is configured to electronically transmit said populated visa application to an embassy, consulate or visa servicing entity for purposes of obtaining a visa.

19. The system according to claim 11, wherein said one or more visa applications is selected from transit visas, airside transit visas, private visas, tourist visas, business visas, student visas, working holiday visas, temporary worker visas, spousal visas or partner visas, marriage visas, immigrant visas, pensioner visas, diplomatic visas, courtesy visas, journalist visas and combinations thereof.

20. The system according to claim 11, wherein said user data is selected from legal name, address, social security number, citizenship, marital status, passport number, bank records, utility bills, mortgage statements and combinations thereof.
